(19) United States
(12) Patent Application Publication
(10) Pub. No.: US 2011/0276520 A1
(43) Pub. Date: Nov. 10, 2011

(54) PROMOTIONAL AND TRANSACTIONAL HOTEL KEYCARD

(76) Inventor: Rami Levi, Beverly Hills, CA (US)

(21) Appl. No.: 12/775,051

(22) Filed: May 6, 2010

(51) Int. Cl. G06Q 90/00

(52) U.S. Cl. 705/500

(57) ABSTRACT

Disclosed is a method of providing an advantage to a hotel by supplying discounts and promotional opportunities to a hotel guest by the use of the hotel keycard. The keycard can access offsite attractions and be used to facilitate transactions among cooperating entities. Purchases made using the keycard offsite can be charged to a hotel guest's room. By using the hotel keycard a hotel guest can take advantage of prearranged discounts by simply presenting the keycard.

### TECHNICAL FIELD

The present system and apparatus relate to a method and hotel keycard for utilizing a hotel keycard to promote a discount network, the hotel and to optionally facilitate payments. In greater detail, a hotel keycard is provided and issued to guests wherein the hotel keycard has associated with the card various promotional discounts and incentives offered by select entities participating in the program. The keycard can be used to complete financial transactions with various cooperating entities.

### BACKGROUND

Tourism is a multi-billion dollar industry. Different hotel and resort companies are continuously battling one another to lure customers to stay at their hotel. In order to lure guests many hotel companies have begun to offer incentives for people to stay at their hotel. These incentives can range from discounts to shows, meals, spa treatments, and the like.

Within the hotel environment the guest is provided with a hotel keycard enabling access to both the room and in house services offered by the establishments to entice guests to stay at the hotel. The keycard may be used by the guest to purchase goods and services within the hotel while having the final bill settled upon checkout.

In greater detail, the hotel keycard may include an optical card, a magnetic card, and an IC card including various systems such as contact/non-contact types or a recordable type medium upon which a variety of information is recorded for use in settling accounts.

Typically, the guest is provided with the keycard with guest information imprinted or imputed upon the card at check-in. After the issuance of the keycard various functions can be performed by the card. Such functions include, a room key, cashless shopping, and in certain cases special menu services in a restaurant based on the contents stored on the keycard. The purchasing history of the guest within the hotel is stored either on the keycard or a separate hotel server, which can then be used to settle the account upon check-out.

However, the keycard and incentives offered by the hotel are limited to the hotel premises. Typically, the guest and particularly tourists travel to a destination to experience the destination and not the hotel. Thus, the offered incentives are limited to that which can be provided by the hotel and not those of the ultimate destination of the tourist.

Additionally, providing hotel keycards and guest incentives is an investment the hotel may not recover. Maintaining the infrastructure for incentives and paying others to provide such services is expensive which increases when a hotel is only partially full.

Accordingly, it would be advantageous for a hotel to provide incentives outside of that which can be offered by the hotel. Thus, what is needed is a method for enticing a guest to stay at a hotel which also provides incentives outside of the services typically offered by hotels. Additionally, it would be beneficial if the convenience of the hotel keycard could be expanded beyond the limited confines of the hotel property.

### SUMMARY

The present system and keycard includes a method of promoting a hotel by incentivizing a hotel guest with promotional opportunities outside of the hotel grounds. The method provides an advantage to a hotel by offering discounts and promotional opportunities to a hotel guest by the use of the hotel keycard. The keycard can access offsite attractions and be used to facilitate transactions among cooperating entities. Purchases made using the keycard can be charged to a hotel guest's room while visiting merchants and attractions not located on hotel grounds or owned by the hotel. By using the hotel keycard a hotel guest can take advantage of prearranged discounts by simply presenting the keycard.

In a further embodiment the keycard may also be loaded with a cash value as a debit card or linked to a credit card network. A hotel guest may have more than one keycard issued for a room. Multiple cards may have different preloaded monetary values depending upon who in the guest's party is to use the designated card. For example, a child may have a smaller limit than a spouse. Additionally, the hotel guest may limit which attractions or merchants a keycard user may interact while using the card. In greater detail, the present invention includes providing a keycard and issuing the keycard to the hotel guest. Optionally, the card may have imprinted upon it the hotel guest's identifying information. The keycard has associated with it promotional discounts and incentives offered by entities which can provide goods or services to the guest. In an embodiment, the entity is not associated with the hotel.

The entity can read the guest's identifying information on the keycard, typically such is stored on a magnetic strip to confirm the guest's eligibility to the discounts and incentives. The entity can bill the hotel for the goods or services provided to the guest. The identifying information found on the keycard provides the proper processing information for the transaction which can be confirmed using a typical point of sale terminal.

Furthermore, the keycard may include printed indicia containing promotional material listing the provided discounts and incentives by entities associated with the keycard. The indicia may include detailed listings of all the available opportunities provided by the keycard outside of the hotel. In a further embodiment, the keycard may include only a select few entities which have chosen to advertise on the card. The entities may be businesses, attractions and parks who desire to attract hotel guests with promotional opportunities.

A further embodiment of the present method simply includes providing a keycard and the hotel issuing the keycard to the hotel guest typically at check-in. Upon check-in the keycard may have imprinted upon it the hotel guest's identifying information. The keycard is associated with a group of entities which have agreed to provide promotional discounts and incentives to the hotel guests upon the presentation of the keycard.

An addition embodiment includes a hotel keycard comprising imprinted information of a hotel guest's identifying information for completing a transaction with an entity providing discounts and incentives to the hotel guest. The keycard additionally includes printed indicia containing promotion material comprising listed promotional discounts and incentives by the entities.

### DRAWINGS

A more complete appreciation of the invention and many of the attendant advantages thereof may be readily obtained by reference to the following detailed description when considered with the accompanying drawings, wherein:

FIG. 1 is an overview flow diagram of the present method and system illustrating the charging of goods and services to a hotel room by entities associated with the keycard;

FIG. 2 is a block flow diagram illustrating the present keycard system wherein the keycard can function as a debit card preloaded by the hotel desk with a monetary amount; and

FIG. 3 is an illustration of a keycard embodiment wherein the card includes both a magnetic strip for encoding information and a barcode, also shown are indicia illustrated graphically which may represent entities and discounts associated with the keycard.

### DETAILED DESCRIPTION

The present system and keycard provides an advantage to a hotel by supplying incentives to a hotel guest by the use of a hotel keycard. The method includes promoting a discount network card through a hotel keycard by incentivizing the hotel guest with promotional opportunities outside of the hotel grounds by the simple use of the hotel keycard. Various businesses agree to provide promotional discounts for the opportunity to sell to the hotel's guests in the method. The provided hotel keycard can purchase goods and services at a discounted price at an offsite businesses with charges billed to the guest's room.

The method provides an advantage to a hotel by using discounts and promotional opportunities to a hotel guest by the use of the hotel keycard. The keycard accesses offsite attractions and transacts with cooperating offsite entities. Purchases made using the keycard can be charged to a guest's hotel room. By using the hotel keycard a hotel guest can take advantage of prearranged discounts by simply presenting the keycard.

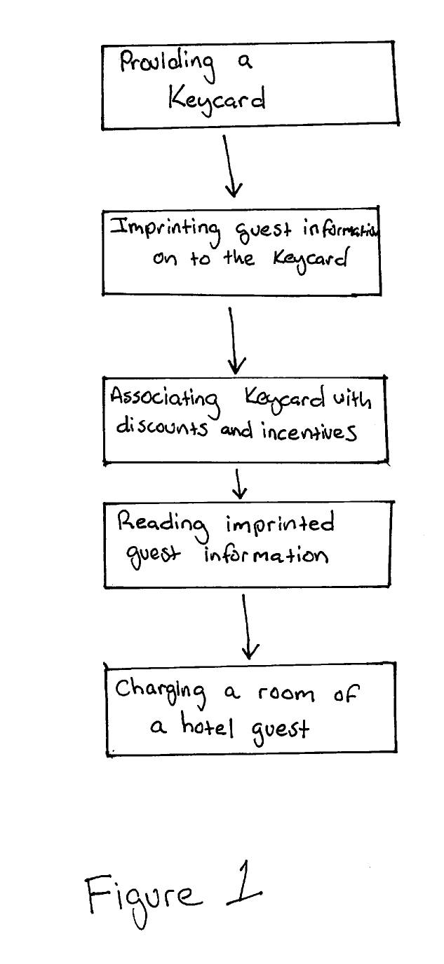

Turning now to the attached drawings, wherein like reference numerals will refer to like elements throughout, FIG. 1 represents an overview flow block diagram of the present method and system illustrating the charging of goods and services to a hotel room by entities associated with the keycard.

The system includes providing a keycard 2 to a hotel. The term “hotel”, in an embodiment, is to be inclusive of all establishments requiring a room key for checking in and staying in a particular place. By way of example, and not limitation, the term “hotel” may include resorts, motels, cruise ships and B and Bs. The term “keycard” may also include in an embodiment resort cards not necessarily designed to open doors but used to access facilities. The keycard can be provided for a fee to the hotel or provided complementary wherein fees are paid by advertisers or the entities as transactional fees when the keycard is used.

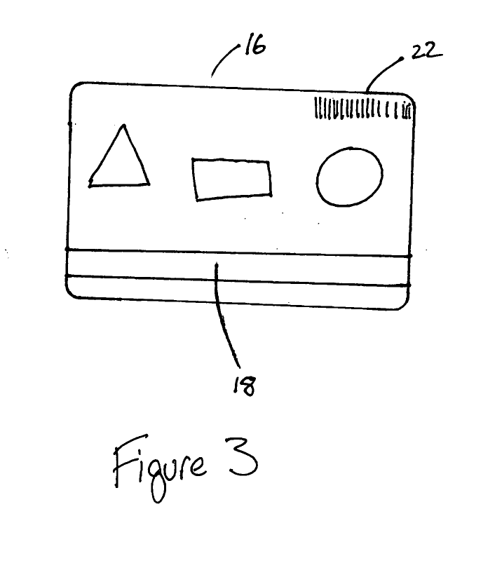

The method illustrated in FIG. 1 further includes the imprinting of guest information onto the keycard 4. Typically the keycard 16 includes a magnetic strip 18 as illustrated in FIG. 3. The imprinting of information to the keycard 16 is done in much the same way as a credit card is imprinted. The imprinted information may contain the room number, name of the guest, length of stay and any preferences of the guest or linked credit card information to the keycard 16. The keycard 16 may also contain encoded information for the routing and transfer of funds.

The method further includes the step of associating the keycard with discount and incentives provided by entities 8. Various entities may be identified in the method willing to associate with the keycard by providing goods and services at a discount. For example, the entity may be a store or tourist destination providing discounts to entice the hotel's guests to shop the store or visit a tourist destination. The use of the keycard provides a convenience in that the card can be used to charge goods and services received from the entities directly to the guest's room at the hotel 14 as in the last step of the figure. The bill can then be settled when the guest checks out of the hotel.

The keycard is designed to work with most any point of sale (POS) terminal to process such a transaction as shown in the step of reading the imprinted guest information 12. When a transaction is completed a transaction fee may be charged as a remittance to the keycard provider or the hotel. The transaction fee typically ranges from between 0.25% to 0.5% of the total transaction, but may vary. The fee may be paid in one embodiment to the hotel and in a further embodiment to the keycard provider.

In a further embodiment of the method of promoting a hotel, the entity is not associated with the hotel. The term “not associated” is meant in an embodiment to mean the entity is not owned or managed by the hotel. In a further embodiment the term may also include the entity provides a service not commonly associated with that provided by a hotel.

The terms “discounts” and “incentives” can be any service or product provided to the guest that would be of value to a guest in an embodiment to entice the guest to both stay at the hotel and visit the entity associated with and accepting the hotel keycard. The associated entities may be associated with one or more hotels and may accept a plurality of hotel keycards for processing

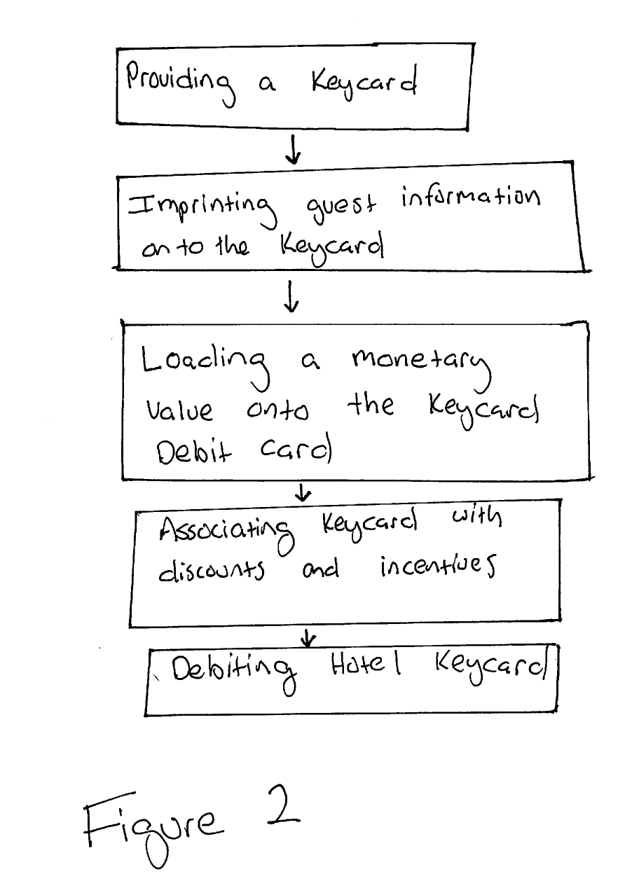

As illustrated in FIG. 2, the keycard 16 may serve as a reloadable debit card or stored value card wherein a monetary amount may be placed on the card by the hotel for the guest. The keycard 16 may include such identifying information for networks of Visa or MasterCard. The debit card function of the keycard 16 provides a wider use for the keycard and allows for various family members to have access to funds in varying amounts in the multiple card embodiment.

The debit card embodiment is very similar to the hotel room debit embodiment except for the loading of the card and the greater acceptance of the card through such networks as Visa. The debit keycard continues to provide discount and incentives at entities participating in the program. Additionally, it is contemplated the keycard may provide a choice of debiting through the traditional transactional networks or as a hotel room charge.

Payment verification for the debit card can be accomplished using such transactional networks as Visa, MasterCard, Amex, ATM or a proprietary system. Example existing ATM/credit card infrastructures include standard computer data processing telecommunications networks for transmitting authorization requests is the VISA® credit transaction network. In addition to VISA® credit cards, merchants connected to this network may seek authorization for approval of transactions involving other credit cards, such as MASTER CARD® and DISCOVER® credit or debits cards. The VISA® credit transaction network includes a plurality of data processors and financial institutions, all interconnected through telecommunication links which, based on a six digit bank identification number (BIN), route all authorization requests to the appropriate card-issuer and all authorization responses back to the requesting authority. Security and verification can be accomplished by various means in the present system. Primarily, the user is identified and confirmed by a password or a PIN number.

Additionally, it is contemplated the keycard may include a point reward system based upon the usage of the keycard for the purchase of goods and services. The points may be redeemed using any of methods often used for credit cards. For example, the points may accumulated for travel awards or for hotel stays.

FIG. 3 illustrates an embodiment of the keycard 16 comprising a magnetic strip 18 for imprinting the guest's information onto the hotel keycard. The hotel keycard 16 may have other forms of recording information thereupon the card 16. For example, as shown in FIG. 3, the card 16 also includes a bar code 22. The card 16 of course may have most any combination of encodable medium located thereupon it for imprinting various desirable information to the keycard 16.

While the embodiments shown are for a keycard it is further contemplated the card may function as a resort card for access to various facilities or functions within the hotel grounds and may not specifically be designated as a keycard. For instance the card may be used in the cruise industry for shipboard identification and for transactions accepted by certain select merchants or shore excursions for discounts and the charging goods and services to the guest's cabin.

The hotel keycard 16 also includes various indicia 20 which can advertise entities participating in the program. The indicia 20 may advertise promotions or discounts in general or provide specific detail as to all participants in the program and the discount available for each. Additionally, it is contemplated the indicia 20 may serve as paid advertisements for generating further income for the method.

While applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A method of promoting a hotel by incentivizing a hotel guest, comprising:
providing a keycard;
issuing the keycard to the hotel guest;
imprinting onto the card the hotel guest's identifying information; and
associating the keycard with promotional discounts and incentives offered by entities providing goods or services to the guest.

2. The method of claim 1, further including the entity reading the guest's identifying information on the keycard to confirm the guest's eligibility to the discounts and incentives.

3. The method of claim 1, further including the entity reading the guest's identifying information on the keycard and billing the hotel for the goods or services provided to the guest.

4. The method of claim 3, wherein the hotel associates a credit card provided by the guest with the keycard to satisfy the billed goods or services.

5. The method of claim 1, further including the keycard including printed indicia containing promotional material listing the provided promotional discounts and incentives.

6. The method of claim 1, wherein the entities comprise a group of businesses forming a discount network not associated with the hotel.

7. The method of claim 1, wherein the entities include parks and attractions offering discounted admissions.

8. The method of claim 1, further including the keycard comprising a stored value card.

9. The method of claim 8, further including the hotel issuing a plurality of keycards to a guest having different monetary values added to the stored value cards.

10. The method of claim 1, wherein a remittance is paid to the provider of the keycard by the entities providing the goods or services to the guest upon the use of the keycard.

11. A method of promoting a hotel by incentivizing a hotel guest, comprising:
providing a keycard and issuing the keycard to the hotel guest;
imprinting onto the card the hotel guest's identifying information; associating the keycard with promotional discounts and incentives offered by entities providing goods or services to the guest, wherein the entities are not associated with the hotel; and
the entity reading the guest's imprinted identifying information on the keycard and confirming the guest's eligibility to the discounts and incentives and billing the hotel for the goods or services provided to the guest.

12. The method of promoting a hotel of claim 11, further including the keycard including printed indicia containing promotional material listing the provided promotional discounts and incentives.

13. The method of claim 11, wherein the entities include parks and attractions offering discounted admissions.

14. The method of claim 11, further including the keycard comprising a stored value card.

15. The method of claim 14, further including the hotel issuing a plurality of keycards to a guest having different monetary values added to the stored value cards.

16. The method of claim 11, wherein a remittance is paid to the provider of the keycard by entities providing the goods or services to the guest upon the use of the keycard.

17. The method of claim 11, further including awarding points for the use of the keycard for transactions whereby the points can be redeemed for goods and services.

18. A hotel keycard comprising;
imprinted information of a hotel guest's identifying information for completing a transaction with an entity providing discounts and incentives to the hotel guest; and
printed indicia containing promotion material listing provided promotional discounts and incentives by the entity.

18. The hotel keycard of claim 18, further including a stored value card.

20. The hotel keycard of claim 19, wherein a plurality of stored value cards are issued to the guest having different monetary values added to the stored value cards.

21. The hotel keycard of claim 18, wherein the keycard is a pass for entry into parks and attractions.
